(19) United States
(12) Patent Application Publication
(10) Pub. No.: US 2005/0171750 A1
(43) Pub. Date: Aug. 4, 2005

(54) Bessel analytic element system and method for collector well placement

(75) Inventors: Victor A. Kelson, Bloomington, IN (US); Mark Bakker, Athens, GA (US); John F. Wittman, Bloomington, IN (US)

Correspondence Address: BAKER & DANIELS LLP, 300 NORTH MERIDIAN STREET, SUITE 2700, INDIANAPOLIS, IN, 46204, US

(73) Assignee: WHPA, Inc.

(21) Appl. No.: 11/045,759

(22) Filed: Jan. 28, 2005

Related U.S. Application Data
(60) Provisional application No. 60/540,728, filed on Jan. 30, 2004.

(51) Int. Cl. G06G 7/48

(52) U.S. Cl. 703/10

(57) ABSTRACT

The present invention involves a method of developing a model of groundwater flow with a well configuration. First, a geographic area is specified with one or more related wells. A mathematical model is created of the groundwater flow in relation to the wells with a plurality of layers, each layer having a local flow component and a leakage component. The plurality of layers is modified based on the leakage component of adjacent layers. The simulation of groundwater flow to a collector well, horizontal well, or gallery may thus be accomplished by specifying an array of line-sink elements that represent the lateral arms of the collector well, horizontal well, or gallery. Boundary conditions for groundwater flow to the lateral arms may then be specified. Groundwater flows are then calculated based on the array and boundary conditions, with updating of the boundary conditions during the calculation. Each of the layers may include a component related to frictional head loss. The head losses due to flow into and within the lateral arms may be used to update the layers. Modifications of the models may involve calculating discharge potentials or a head specified condition.

This application claims benefit of U.S. Provisional Patent Application No. 60/540,728 filed Jan. 30, 2004.

### SOURCE CODE APPENDIX

This application includes a computer software specification listing appendix submitted with the aforementioned U.S. Provisional Patent Application No. 60/540,728 filed Jan. 30, 2004, the disclosure of which is incorporated by reference herein. A portion of the disclosure of this patent document contains material which is the subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### BACKGROUND OF THE INVENTION

1. Field of the Invention

The field of the invention is the computer modelling of steady-state groundwater flow in relation to collector wells, horizontal wells and galleries.

2. Description of the Related Art

A horizontal collector well is a well that is constructed by building a caisson that penetrates much of the vertical extent of an aquifer, then extending “lateral arms”, constructed of perforated pipe or wound well screens, into the aquifer. Compared to a traditional vertical well, a horizontal collector well provides much larger pumping capacity with less drawdown in head. Furthermore, the lateral arms of a horizontal collector well can be built very close to (or even underneath) surface waters, increasing the ability of the well to induce aquifer recharge from surface waters. As a result, collector wells and horizontal wells are commonly used in public drinking water supply or industrial water supply applications.

In water resource planning, it is important to understand the source of groundwater that is moving to wells, to be able to predict the quantity of water that can be removed from an aquifer system, to predict the effects of new groundwater development on existing facilities, and to understand the potential for contamination of well water. Computer models of groundwater flow are commonly used in these applications, but collector wells pose a particularly challenging problem. Since the amount of water that can be abstracted by a collector well is large, its effects on groundwater flow are expressed over a large regional extent; however, the performance of the collector well is greatly influenced by local factors, such as three-dimensional flow in porous media, resistance to flow into and out of surface waters, and head losses resulting from flow into the lateral arms and within the lateral arms.

We are aware of only a few published computational models of collector wells. In general, the prior art can be separated into three categories: (1) numerical models based on finite-difference or finite-element approximations; (2) fully three-dimensional models using analytical solutions; and (3) approximate two-dimensional solutions.

Finite-Difference and Finite-Element Approximations

A variety of numerical methods have been employed to simulate groundwater flow to collector wells. Many collector wells have been modelled by consultant with finite difference techniques (e.g., Sonoma County Water Agency, Louisville Water Company) but in each case the models are necessarily limited in the representation of regional flow, or in the representation of the near field conditions near the lateral arms of the collector.

### EXAMPLE 1

Danicic, D. and R. Long, 2003. Groundwater Modelling: Infrastructure Planning for Well Field Expansion, presented at the Pacific NorthWest AWWA Section meeting.

Their model was built to evaluate options for developing a new source of supply for the City of Newberg, Oreg. The city well field is situated along the Willamette River in the sand and gravel outwash aquifer. They used a finite element model of groundwater flow (MICRO-FEM) to simulate flow near the well and into the area around the well field.

### EXAMPLE 2

Cunningham, W. L., E. S. Bair, and W. P. Yost. 1995. Hydrogeology and Simulation of Ground-Water Flow at the South Well Field, Columbus, Ohio. USGS. WRI-95-4279.

The three-dimensional, ground-water-flow model was constructed by use of the U.S. Geological Survey three-dimensional finite-difference ground-water-flow code. Recharge, boundary flux, and river leakage are the principal sources of water to the flow system. The study area is bounded on the north and south by streamlines, with flow entering the area from the east and west.

The numerical model contains 53 rows, 45 columns, and 3 layers. The uppermost two layers represent the glacial drift. The bottom layer represents the carbonate bedrock. The horizontal model grid is variably spaced to account for differences in available data and to simulate heads accurately in specific areas of interest. The length and width of grid cells range from 200 to 2,000 feet; the finer spacings are designed to increase detail in the areas near the collector wells. The model was developed to identify the contributing recharge area of the well and to consider the effects of low flows on yield.

### EXAMPLE 3

FISHTRAP ISLAND COLLECTOR WELL, City of Prince George, Canada. Golder and Associates. 2003. Capture Zone Analysis, Contaminant Inventory and Preliminary Groundwater, Monitoring Plan, City of Prince George, Canada

Assessed environmental impact of a proposed collector well. Found none. http://www.eao.gov.bc.ca/epic/output/html/deploy/epic_document_{—}209_{—}15598.html.

### EXAMPLE 4

Kim, G., Koo, J., Shim, J., Shon, J., and Lee, S., 1999. A study of methods to reduce groundwater contamination around a landfill in Korea. Journal of Environmental Hydrology. (7), paper 10. The contaminant transport model MT3D was used to simulate flow in a contaminated aquifer. The model was constructed to assess the feasibility of capturing contaminants leaching from a sanitary landfill towards streams along the perimeter of the area. Modelling was used to assess the relationship between the number of extraction wells and the capture efficiency of migrating contaminants in the aquifer. The authors modelled hypothetical barrier walls and an increasing number of radial collector wells (simulated with MODFLOW drain cells) to determine the costs of increasing fractions of the contaminant removal.

Fully three-dimensional models using analytical solutions

We are able to identify five primary sources of research and publication of work done to develop fully 3-dimensional solutions for a radial collector well. In chronological order they are:

### EXAMPLE 1

Hantush, M. S. and I. S. Papadopulos, 1963, *Flow of Ground Water to Collector Wells (Closure)*. Proceedings, American Society of Civil Engineers,/Journal of the Hydraulics Division/, HY4, p. 225-227.

Hantush, M. S. and I. S. Papadopulos, 1962, *Flow of Ground Water to Collector Wells*. Proceedings, American Society of Civil Engineers, /Journal of the Hydraulics Division/, HY5, pp. 221-224.

### EXAMPLE 2

Radojkovic M and Pecaric J. 1984. Three-Dimensional Boundary Element Model of Groundwater Flow to Ranney Wells. 1984, pp.4. 63-4. 75.

### EXAMPLE 3

David Steward (currently at the University of Kansas) has published a fully three-dimensional solution in his Ph.D. dissertation (University of Minnesota).

### EXAMPLE 4

Ken Luther (currently at Valparaiso University) has published a fully three-dimensional solution in an unconfined aquifer.

### EXAMPLE 5

Hongbin Zhan (currently at Texas A&M University) has published a transient analysis for pumping-test type curves in horizontal wells.

Approximate two-dimensional analytic element solutions

We know of two published examples of a collector well models using analytic elements. Neither includes the flow inside the lateral arms.

### EXAMPLE 1

Strack [1989] provides an illustration of a radial collector modeled with line-dipole elements.

### EXAMPLE 2

GFLOW 2000 (Haitjema Software, LLC) supports a two-dimensional gallery element. Haitjema software provides a monograph explaining ways to estimate “effective resistance” parameters for horizontal wells.

In addition, Victor Kelson has implemented a two-dimensional prototype version of groundwater modelling code. This code includes entry resistance on the lateral arms and resistance to flow within the lateral arms.

None of the two-dimensional solutions account explicitly for the vertical resistance of the aquifer or stream-collector-aquifer interactions.

### SUMMARY OF THE INVENTION

The present invention provides an efficient approximation to three dimensional simulation of groundwater flow in a series of collector wells by modelling both the layers of the groundwater environment and effectively calculating the leakage between layers. The local effects, the layers, are modelled by equations that are easily calculated, and the global effects in the groundwater system of the individual layers is easily integrated into a global perspective by the leakage between layers. In this manner, local conditions, specified by noting the boundary conditions of the line sinks of the lateral arms. The length of the arms and the sink densities are included in the modelling, as well as the friction analysis of the head loss. The resulting model may be solved for the pumping rate, in the case of a discharge-specified well, or the discharge rate, showing the potential yield of the well.

This invention is a practical computational model of groundwater flow to a collector well, horizontal well, or gallery. It will find applications in environmental science, civil and environmental engineering, water resource management, hydrology, and geology. The invention is a steady-state computer model of a horizontal collector well that makes use of “Bessel” analytic elements. The model also supports the simulation of horizontal wells and galleries. The horizontal collector well model is a module that has been added to the Bessel analytic element code TimML [Bakker, 2003]. TimML is a computational code written in the Python language that has been released to the public under the GNU LGPL license.

The principles of modelling groundwater flow using the analytic element method are published elsewhere [e.g. Strack, 1989; Haitjema,1995]. “Bessel” analytic elements are analytical solutions to groundwater flow that include leakage to and from adjoining layers, e.g. in semiconfined aquifers. Bakker [2002, 2003] has developed a practical computer code that simulates steady-state, quasi-three-dimensional groundwater flow using Bessel analytic elements. In this code, the aquifer(s) are represented by horizontal “slices”, each a continuum of piecewise-constant properties. The problem formulation separates the groundwater flow problem into two parts: (1) a harmonic solution that can be solved using “traditional” analytic elements (e.g. after Strack [1989]); and (2) a non-harmonic leakage solution that may be solved using Bessel analytic elements. Bakker [2002] has demonstrated an accurate solution for groundwater flow to a partially-penetrating well in a confined aquifer using Bessel analytic elements.

This invention applies the Bessel analytic element model TimML to explicitly simulate flow to collector wells, horizontal wells, and galleries. This was accomplished by:
1. Devising a strategy for arranging an array of line-sink elements that represent the lateral arms of the collector well
2. Specifying boundary conditions for groundwater flow to the lateral arms, including the head losses due to flow into and within the lateral arms
3. Modifying the solution strategy of TimML to include an explicit procedure for updating the boundary conditions in (2).

The resulting model allows the simulation of all factors that affect the performance and effects of a horizontal collector well, horizontal well, or gallery. It improves on the prior art in the following ways:
Explicitly simulates the interactions between the collector well, nearby surface waters, and three-dimensional flow in porous media
Can be efficiently included in a large-scale regional model, in order to account for the effects of the collector on neighboring wells and other water users
Provides an analytically-accurate potentiometric head and velocity field
Allows for accurate computation of streamlines and travel times for groundwater flow

The invention improves on the prior art in the following ways:

Explicitly accounts for all aspects of collector well performance, including entry resistance and frictional resistance within the collector arms.

Explicitly accounts for vertical flow from surface waters to collectors by the use of a layered, Bessel analytic element formulation.

Makes it possible to “imbed” a fully explicit model of a collector well in a regional quasi-three-dimensional regional model, accounting for the regional effects of the collector.

Computationally efficient solution for the 3-D problem near the well.

This is the first application of Bessel the first application of Bessel analytic elements to the problem of modelling horizontal collector wells, horizontal wells, and galleries. This model improves on previous collector well models with line-sink elements: Manages the vertical flow that is ignored in the two-dimensional approximations, and includes vertical interactions between lateral arms and surface waters; Capable of solving general regional-scale problems that fully three-dimensional models cannot manage; and Includes features such as frictional head losses within lateral arms. We claim that this model improves on previous collector well models based on finite-difference and finite-element formulations: Explicitly represents the geometry of the collector well; and Includes features such as frictional head losses within lateral arms.

### BRIEF DESCRIPTION OF THE DRAWINGS

The above-mentioned and other features and objects of this invention, and the manner of attaining them, will become more apparent and the invention itself will be better understood by reference to the following description of embodiments of the invention taken in conjunction with the accompanying drawings, wherein:

FIG. 1 is a schematic representation of line-sink elements in a collector well.

Corresponding reference characters indicate corresponding parts throughout the several views. Although the drawings represent embodiments of the present invention, the drawings are not necessarily to scale and certain features may be exaggerated in order to better illustrate and explain the present invention. The exemplifications set out herein illustrate embodiments of the invention in several forms and such exemplification is not to be construed as limiting the scope of the invention in any manner.

### DESCRIPTION OF INVENTION

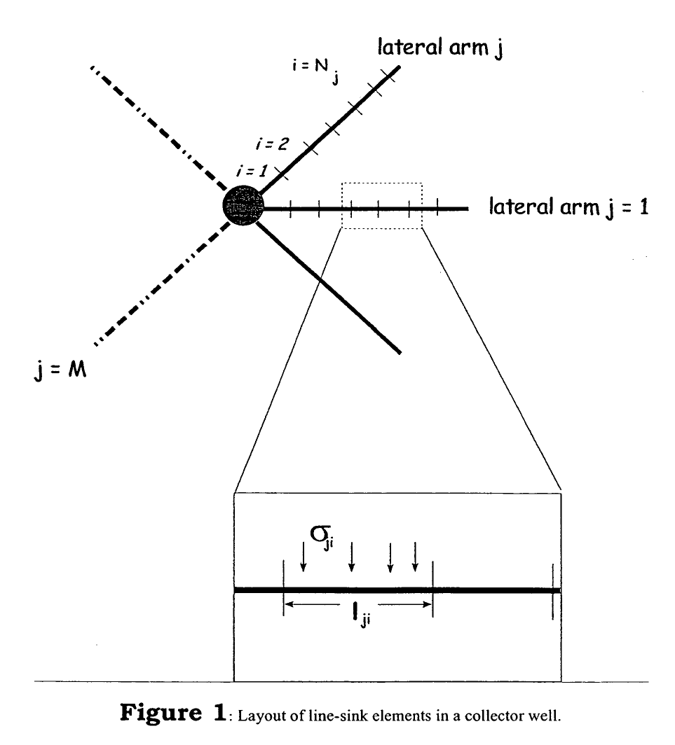

The collector well is modelled as a collection of line-sink elements as follows. Consider the collector well in FIG. 1 The collector well is composed of M lateral arms. For lateral arm j; j=1 . . . M, the arm length is Lⱼ the radius of the arm is rⱼ, and the lateral arm is located in model layer kⱼ. We divide each lateral arm j into Nⱼ segments. For segment i of lateral armj (where i=1 at the caisson), the segment length lⱼᵢ i=1 at the caisson), the segment length lⱼᵢ is computed as

$$\begin{matrix}{l}_{ji} = {L}_{j} \times \frac{{N}_{j} - i + 1}{{S}_{j}} & ( 1 ) \\ where & \\ {S}_{j} = \sum {i}_{i = 1}^{Nj} & ( 2 )\end{matrix}$$

This arrangement results in shorter line-sinks at the tips of the lateral arms, and improves the accuracy of the solution. Each line-sink element has a sink density (in volume of water per day per unit length) of σⱼᵢ, and the head in the aquifer at all points near the collector well is a priori unknown. The modeller provides an entry resistance cⱼᵢ at each line-sink, which accounts for the head loss that may occur as water moves from the aquifer into the lateral arm through the well screen or any fine materials that may collect there in the aquifer (commonly referred to as a “skin” effect). We place a collocation point at the center of each line-sink(xⱼᵢ, yⱼᵢ) where the boundary conditions are to be met. At the collocation point for segment i of lateral arm j, the sink density may be written as

$${σ}_{ji} = \frac{2 π {r}_{j}}{{c}_{ji}} ( {ϕ}_{aquifer} - {ϕ}_{lateral} ) \qquad ( 3 )$$

where φ_{aquifer} is the head outside the lateral arm and φₗₐₜₑᵣₐₗ is the head inside the lateral arm at the collocation point. This expression may be solved for the head in the lateral,

$${ϕ}_{lateral} = {ϕ}_{aquifer} - \frac{{σ}_{ji} {c}_{ji}}{2 π {r}_{j}} \qquad ( 4 )$$

In TimML, calculations are performed in terms of “discharge potentials”. The discharge potential Φ in layer k is defined as
Φₖ=Tₖφₖ (5)
where Tₖ is the transmissivity of layer k and Φₖ is the head in layer k. The contribution of line-sink element i of lateral arm j to the potential at any location (x, y) in layer k is computed by multiplying the sink density σⱼᵢ by an influence function Fⱼᵢ(x, y, k), which is provided in Bakker. At the collocation point (xⱼᵢ, yⱼᵢ), the total potential is computed as:

$$Φ ( {x}_{ji} , {y}_{ji} , {k}_{j} ) = {\sum }_{J = 1}^{M} {\sum }_{I = 1}^{Nj} {σ}_{JI} {F}_{JI} ( {x}_{ji} , {y}_{ji} , {k}_{j} ) + {Φ}_{other} \qquad ( 6 )$$

where Φₒₜₕₑᵣ is the sum of the potential contributions of all other elements in the model. Combining 4 with 6 and recalling the definition of the discharge potential 5 yields the following expression for the head in the lateral,

$${ϕ}_{lateral} ( {x}_{ji} , {y}_{ji} , {k}_{j} ) = \frac{1}{{T}_{k j}} {\sum }_{J = 1}^{M} {\sum }_{I = 1}^{{N}_{j}} {σ}_{JI} {F}_{JI} ( {x}_{ji} , {y}_{ji} , {k}_{j} ) + {Φ}_{other} - \frac{{σ}_{ji} {c}_{ji}}{2 π {r}_{j}} \qquad ( 7 )$$

Expression 7 yields Σⱼ₌ₗ^{M}Nⱼ equations for the Σⱼ₌ₗ^{M}Nⱼ unknown values σⱼᵢ. We write these equations as follows:

At the caisson, the heads in all laterals are equal. For all laterals except the first lateral (J>1), we write the boundary conditions as
φₗₐₜₑᵣₐₗ(xⱼₗ, yⱼ₁, kⱼ)=φₗₐₜₑᵣₐₗ(xₗ₁, yₗ₁, kₗ) (8)

This yeilds M−1 equations.

At all control points along lateral arms (i>1), the difference in head along the arms between adjoining control points, is a function of the total amount of in the arm at the control point,
φₗₐₜₑᵣₐₗ(xⱼᵢ, yⱼᵢ, kⱼ)−φₗₐₜₑᵣₐₗ(xⱼᵢ, −l, yⱼᵢ−l, jⱼ)=ƒ(Qⱼᵢ, φₗₐₜₑₐₗ(xⱼᵢ, yⱼᵢ, kⱼ)) (9)

Where the total flow in the arm, Qⱼᵢ is computed from the lengths and sink densities of the line-sink elements for the lateral arm,

$${Q}_{ji} = {\sum }_{I = i}^{Nj} {σ}_{jI} {l}_{jI} \qquad ( 10 )$$

For the collector well model, the function ƒ is based on a Moody friction factor which is provided by the modeller, based on the material that comprises the lateral arm. If an improved expression for the head loss along the arm is available, it may be substituted in the computer code, e.g. a channel-flow expression will be used for galleries.

This yields Σⱼ₌₁^{M}Nⱼ−1 equations.

The final equation can be provided in either of two forms: (1) the modeller provides the pumping rate (discharge-specified well); or (2) the modeller provides the head in the caisson (head-specified well). Case (2) is to be used when the modeller desires to know the possible yield of the collector well. These boundary conditions are as follows.

Discharge-Specified Condition

The discharge-specified condition is
φₗₐₜₑᵣₐₗ(xₗ₁, yₗ₁, kₗ)=φ_{w} (11)
where Q_{w} is the total pumping rate of the well.
Head-Specified Condition

The head-specified condition is
φₗₐₜₑᵣₐₗ(xₗ₁, yₗ₁, kₗ)=φ_{w} (12)
where φ_{w} is the specified head in the caisson.
Solution Strategy

The friction-loss equations in 9 require that an iterative solution procedure be used. The model first pre-conditions the model with an initial estimate of all σⱼᵢ, then computes initial estimates of the values Øₗₐₜₑᵣₐₗ(xⱼᵢ, yⱼᵢ, kⱼ)−Øₗₐₜₑᵣₐₗ(xⱼᵢ₋₁, yⱼᵢ₋₁, jⱼ) using expressions 9 and 10. Now, a direct solution for all σⱼᵢ is performed using a full matrix solver. A Gauss-Seidel approach is used to improve the estimate of Øₗₐₜₑᵣₐₗ(xⱼᵢ, yⱼᵢ, kⱼ)−Øₗₐₜₑᵣₐₗ(xⱼᵢ₋₁, yⱼᵢ₋₁, jⱼ), based on the improved values of σⱼᵢ. For most problems, the solution converges in 3-4 Gauss-Seidel iterations.

Alternative friction-loss equations are also compatible with the present invention. For example, different soil, piping, filtering, and other configurations may point to a different friction-loss equation as being more suitable for a particular location or configuration. The exemplary embodiment of the invention uses a good general purpose friction-loss equation to provide reasonable modelling of the underlying conditions.

The process utilizing the present invention allows a planner to develop a model of groundwater flow within a well configuration. First, the planner specifies a geographic area in conjunction with one or more related wells. The planner then creates a mathematical model of groundwater flow in relation to the wells with a plurality of layers. Each layer has a local flow component and a leakage component defined by the planner. Using software according to the present invention, The layers are modified based on the leakage component of adjacent layers.

The planner may simulate groundwater flow to a collector well, horizontal well, or gallery by specifying an array of line-sink elements that represent the lateral arms of the collector well, horizontal well, or gallery. In order to effect such a simulation, the planner must also specify boundary conditions for groundwater flow to the lateral arms. Software may then calculate groundwater flows based on the array and boundary conditions. The present invention provides the aforementioned advantages by updating the boundary conditions during the calculation.

Each of the layers may have a model component related to frictional head loss specified by the planner so that calculations involving a component of each layer are related to that frictional head loss. The definition of the layers may include using the head losses due to flow into and within the lateral arms. The calculations may also involve discharge potentials. Finally, the calculations may specifying determining either the discharge-condition or a head specified condition.

While this invention has been described as having an exemplary design, the present invention may be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains.

1. A method of developing a model of groundwater flow with a well configuration comprising the steps of:
specifying a geographic area and one or more related wells;
creating a mathematical model of groundwater flow in relation to the wells
with a plurality of layers, each layer having a local flow component and a leakage component; and
modifying said plurality of layers based on the leakage component of adjacent layers.

2. The method of claim 1 wherein the step of creating includes creating for each of the layers a component related to frictional head loss.

3. The method of claim 2 wherein the step of specifying includes calculating a component of each said layer related to frictional head loss.

4. The method of claim 1 wherein the step of specifying layers includes using the head losses due to flow into and within the lateral arms.

5. The method of claim 1 wherein the step of modifying involves calculating discharge potentials.

6. The method of claim 1 wherein the step of modifying includes specifying one of a discharge-condition and a head specified condition.

7. A method of simulate groundwater flow to a collector well, horizontal well, or gallery comprising the steps of:
specifying an array of line-sink elements that represent the lateral arms of the collector well, horizontal well, or gallery;
specifying boundary conditions for groundwater flow to the lateral arms;
calculating groundwater flows based on the array and boundary conditions; and
updating the boundary conditions during the calculating step.

8. The method of claim 7 wherein the step of specifying boundary conditions includes using the head losses due to flow into and within the lateral arms.

9. The method of claim 7 wherein the step of calculating involves calculating discharge potentials.

10. The method of claim 7 wherein the step of specifying boundary conditions includes specifying one of a discharge-condition and a head specified condition.

11. The method of claim 7 wherein the step of specifying an array includes specifying a plurality of layers, each layer having a local flow component and a leakage component.

12. The method of claim 11 wherein in the step of specifying includes calculating a component of each said layer related to frictional head loss.
